(19) United States
(12) Patent Application Publication
(10) Pub. No.: US 2011/0168513 A1
(43) Pub. Date: Jul. 14, 2011

(54) FREEWHEEL STRUCTURE

(76) Inventor: Luis A.A. FILIPE, Macau (CN)

(21) Appl. No.: 12/686,369

(22) Filed: Jan. 12, 2010

(51) Int. Cl. F16D 23/00

(52) U.S. Cl. 192/64

(57) ABSTRACT

A freewheel structure includes a freewheel. The freewheel has a teethed portion formed on an outer periphery thereof for adapting to engage with a bicycle chain. The freewheel has a pivotal hole centrally defined therein and extending therethrough for adapting to receive a spindle. The freewheel has a position portion disposed on an inner end of the pivotal hole for adapting to connect with a bicycle hub. The position portion of the freewheel is single-directionally and ratchetably rotated relative to the hub.

### BACKGROUND OF THE INVENTION

1. Field of the Invention

The present invention relates to a freewheel structure, and more particularly to an integrally molded freewheel structure.

2. Description of Related Art

A conventional freewheel assembly includes a freewheel 11, a spindle 12 mounted in the freewheel 11. A hub assembly 13 is movably mounted on the spindle 12. The hub assembly 13 has a hub 131 and a ratcheting sleeve 132 ratchetably received in the hub 131. The hub 131 is provided for connecting to a plurality of spokes (not shown). The ratcheting sleeve 132 is fixed on the freewheel 11. The hub 131 is single-directionally ratchetably rotated relative to the ratcheting sleeve 132. When a chain (not shown) drives the freewheel 11 to be rotated in a forward direction, the freewheel 11 is engaged with the hub assembly 13 to drive a bicycle wheel (not shown). When the chain drives the freewheel 11 to be rotated in a reversal direction, the freewheel 11 with the ratcheting sleeve 132 are ratchetably disengaged with the hub 131 such that the bicycle wheel is idle driven.

The conventional bicycle freewheel assembly has several defects as following described:

1. There are various tolerances between the spindle 11 and the ratcheting sleeve 132, the hub 131 and the ratcheting sleeve 132, and the ratcheting sleeve 132 and the freewheel 11. Those tolerances effect the stability of the freewheel assembly such that the operating life of the freewheel assembly is decreased;

2. The conventional freewheel assembly is assembled with multiple elements. The structure of the conventional freewheel assembly is complex. It takes a lot of time and causes a difficult for assembling.

The present invention has arisen to mitigate and/or obviate the disadvantages of the conventional freewheel assembly.

### SUMMARY OF THE INVENTION

The main objective of the present invention is to provide an improved integrally molded freewheel.

To achieve the objective, a freewheel structure in accordance with the present invention comprises freewheel. The freewheel has a teethed portion formed on an outer periphery thereof for adapting to engage with a bicycle chain. The teethed portion is composed of a serious sizes of sprockets. The serious sizes of sprockets are descendingly arranged such that the freewheel is formed to be a tapered shape. Each sprocket has a plurality of teeth formed on an outer periphery thereof for adapting to engage with the bicycle chain. The freewheel has a pivotal hole centrally defined therein and extending therethrough for adapting to receive a spindle. The freewheel has a position portion disposed on an inner end of the pivotal hole for adapting to connect with a bicycle hub. The position portion is laterally located a maximum sized sprocket of the serious sizes of sprockets. A bearing is mounted on an outer end of the pivotal hole for provided a stability. The position portion has a plurality of ratchet sheets mounted around the position portion provided for single-directionally ratchetably engaging with the hub. Each ratchet sheet having an elastic member mounted thereon for elastically abutting against a corresponding ratchet sheet for providing an elastic restoring force.

When the chain drives the freewheel to be rotated in a forward direction, the plurality of ratchet sheets of the freewheel are engaged with the hub to rotatably drive the hub. When the chain drives the freewheel to be rotated in a reversal direction, the plurality of ratchet sheets of the freewheel are ratchetably disengaged such that the hub is idle driven relative to the freewheel.

The freewheel structure in accordance with the present invention provides the following advantages relative to the conventional freewheel assembly. The freewheel is directly mounted on the spindle and single-directionally engaged with the hub. The freewheel of the conventional freewheel assembly is connected with the spindle via the ratcheting sleeve. Therefore, the freewheel structure in accordance with the present invention decreases tolerances between the structural elements and increases the operational stability such the operational lift is increased. The freewheel structure in accordance with the present invention lacks the ratchet sleeve of the conventional freewheel assembly such that the structure of the freewheel structure in accordance with the present invention is simple for promoting a assembling speed.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a freewheel structure in accordance with the present invention;

FIG. 2 is a partial assembled perspective view of the freewheel structure in accordance with the present invention;

FIG. 3 is a side plan view of a freewheel of the freewheel structure in accordance with the present invention in partial cross-section; and

FIG. 4 is an exploded perspective view of a conventional freewheel assembly in accordance with the prior art.

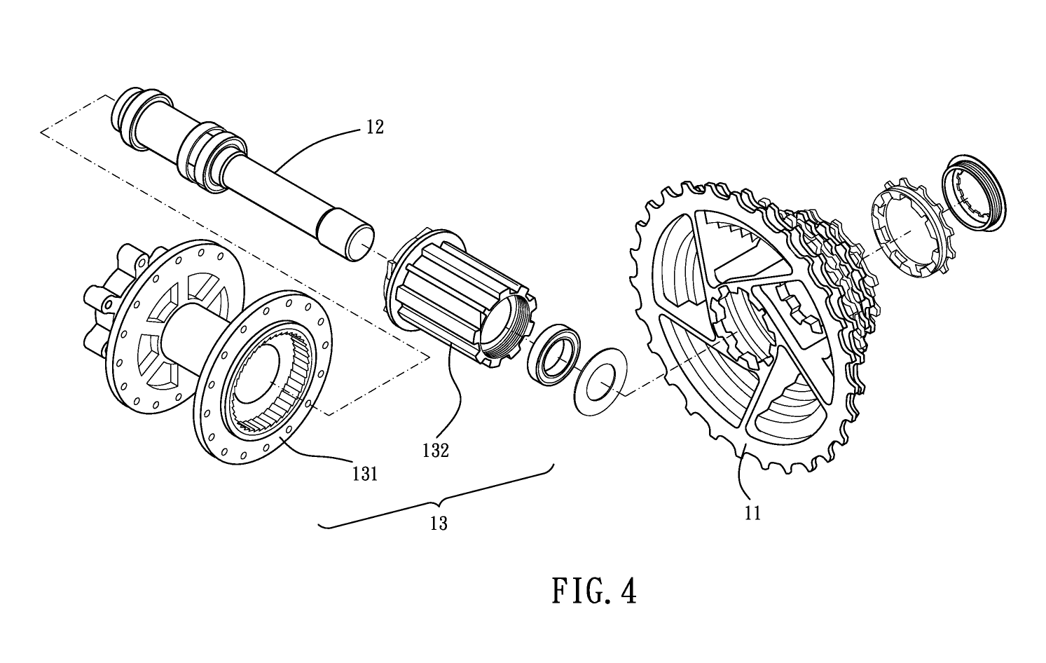

### DETAILED DESCRIPTION OF THE INVENTION

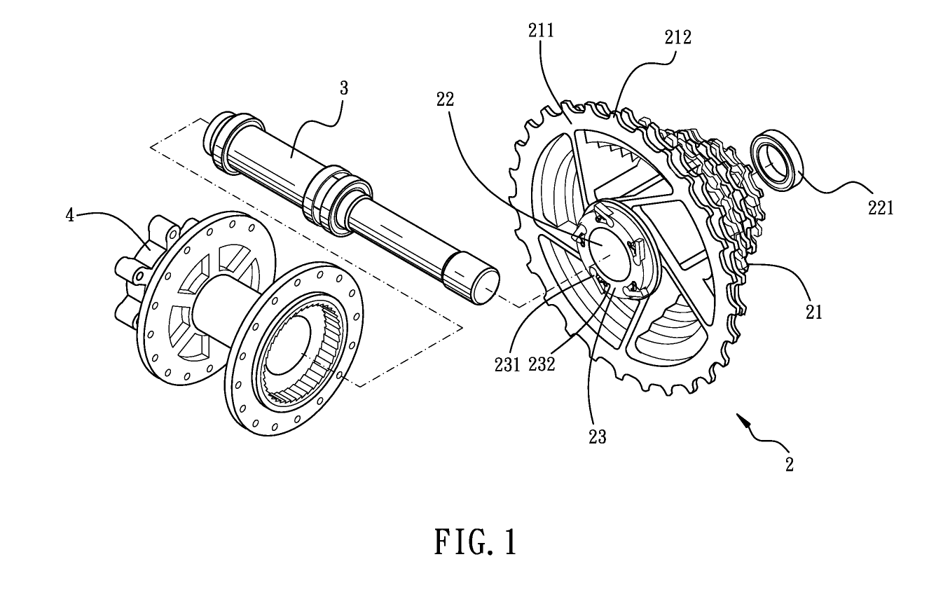

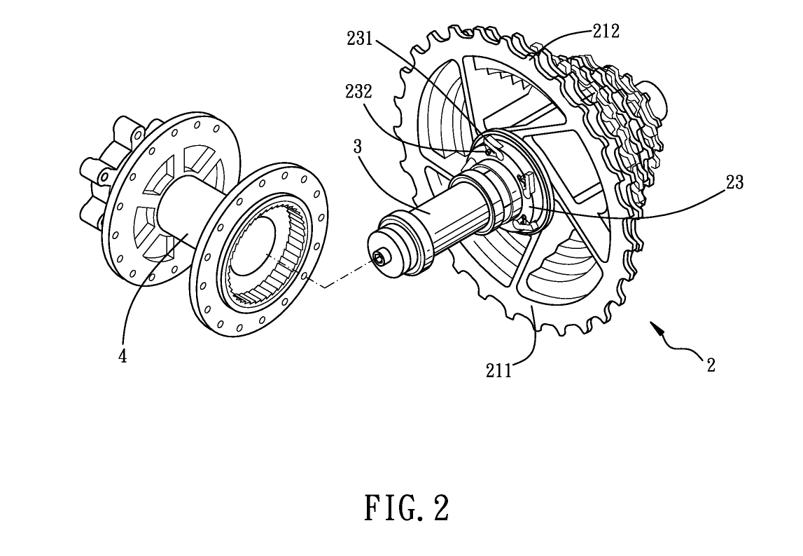

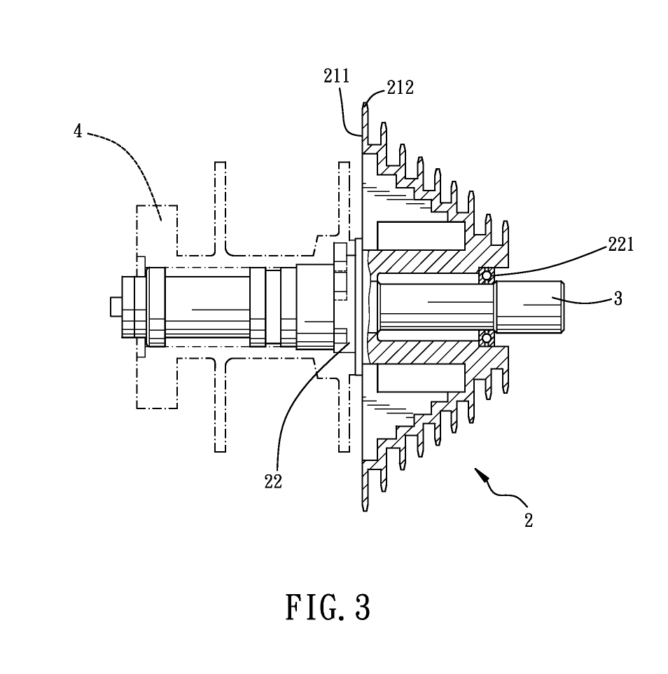

Referring to the drawings and initially to FIGS. 1-3, a freewheel structure in accordance with the present invention comprises a freewheel (2). The freewheel (2) is integrally molded. The freewheel (2) has a teethed portion (21) formed on an outer periphery thereof for adapting to engage with a bicycle chain (not shown). The teethed portion (21) is composed of a serious sizes of sprockets (211) (not shown). The serious sizes of sprockets (211) are descendingly arranged such that the freewheel (2) is formed to be a tapered shape. Each sprocket (211) has a plurality of teeth (212) formed on an outer periphery thereof for adapting to engage with the bicycle chain. The freewheel (2) has a pivotal hole (22) centrally defined therein and extending therethrough for adapting to receive a spindle (3). The freewheel (2) has a position portion (23) disposed on an inner end of the pivotal hole (22) for adapting to connect with a bicycle hub (4). The position portion (23) is laterally located a maximum sized sprocket of the serious sizes of sprockets (211). A bearing (221) is mounted on an outer end of the pivotal hole (22) for provided a stability. The position portion (23) has a plurality of ratchet sheets (231) mounted around the position portion (23) provided for single-directionally ratchetably engaging with the hub (4). Each ratchet sheet (231) having an elastic member (232) mounted thereon for elastically abutting against a corresponding ratchet sheet (231) for providing an elastic restoring force.

When the chain drives the freewheel (2) to be rotated in a forward direction, the plurality of ratchet sheets (231) of the freewheel (2) are engaged with the hub (4) to rotatably drive the hub (4). When the chain drives the freewheel (2) to be rotated in a reversal direction, the plurality of ratchet sheets (231) of the freewheel (2) are ratchetably disengaged such that the hub (4) is idle driven relative to the freewheel (2).

The freewheel structure in accordance with the present invention provides the following advantages relative to the conventional freewheel assembly.

The freewheel (2) is directly mounted on the spindle (3) and single-directionally engaged with the hub (4). The freewheel of the conventional freewheel assembly is connected with the spindle via the ratcheting sleeve. Therefore, the freewheel structure in accordance with the present invention decreases tolerances between the structural elements and increases the operational stability such the operational lift is increased.

The freewheel structure in accordance with the present invention lacks the ratchet sleeve of the conventional freewheel assembly such that the structure of the freewheel structure in accordance with the present invention is simple for promoting a assembling speed.

Although the invention has been explained in relation to its preferred embodiment, it is to be understood that many other possible modifications and variations can be made without departing from the spirit and scope of the invention as hereinafter claimed.

What is claimed is:

1. A freewheel structure comprising:
a freewheel, the freewheel having a teethed portion formed on an outer periphery thereof for adapting to engage with a bicycle chain, the freewheel having a pivotal hole centrally defined therein and extending therethrough for adapting to receive a spindle, the freewheel having a position portion disposed on an inner end of the pivotal hole for adapting to connect with a bicycle hub;
wherein the position portion of the freewheel is single-directionally and ratchetably rotated relative to the hub.

2. The freewheel structure as claimed in claim 1, wherein the position portion has a plurality of ratchet sheets mounted around the position portion provided for single-directionally ratchetably engaging with the hub, each ratchet sheet having an elastic member mounted thereon for elastically abutting against a corresponding ratchet sheet for providing an elastic restoring force.

3. The freewheel structure as claimed in claim 1 further comprising a bearing mounted on an outer end of the pivotal hole for provided a stability.

4. The freewheel structure as claimed in claim 1, wherein the teethed portion is composed of a serious sizes of sprockets, the serious sizes of sprockets descendingly arranged such that the freewheel is formed to be a tapered shape, each sprocket having a plurality of teeth formed on an outer periphery thereof for adapting to engage with the chain.

5. The freewheel structure as claimed in claim 4, wherein the position portion is laterally located a maximum sized sprocket of the serious sizes of sprockets.
